(19) United States
(12) Patent Application Publication
(10) Pub. No.: US 2026/0339745 A1
(43) Pub. Date: Oct. 29, 2026

(54) ZIGBEE-ENABLED CLOUD CONTAINER RESOURCE OPTIMIZATION SYSTEM

(71) Applicant: Bank of America Corporation, Charlotte, NC (US)

(72) Inventor: Vinod Maghnani, Gurugram Haryana (IN)

(21) Appl. No.: 19/188,194

(22) Filed: Apr. 24, 2025

(51) Int. Cl. G06F 9/50; G06F 9/48; H04L 67/12

(52) U.S. Cl. CPC G06F 9/5072; G06F 9/4881; G06F 9/5027; H04L 67/12

(57) ABSTRACT

A system for scheduling executable jobs within a cloud container is provided. The system may involve a Zigbee communication engine, a deep neural network and one or more processing queues. The deep neural network may create a schedule for a plurality of execution jobs. The schedule may be based on a resource availability. The schedule may involve parallel and concurrent processing. The system may use the schedule to trigger the execution of executable jobs within the one or more processing queues.

### FIELD OF TECHNOLOGY

Aspects of the disclosure relate to cloud computing containers.

### BACKGROUND OF THE DISCLOSURE

Currently, organizations manage a large variety of applications within a distributed cloud environment. Such applications include and/or perform user-facing services, batch jobs, stream processing, iterative computations and maintenance services. Each of the applications may execute one or more executable jobs. Because the executable jobs share resources within the cloud environment, resources may be allocated to specific jobs.

Current allocation systems assume that a job requires a fixed number of cloud resources, such as cloud containers. However, current allocation systems do not capture the dynamic nature of the resource utilization of an executable job. As such, users or systems may overestimate resource requirements thereby depriving other bandwidth needs from the resources used to meet the overestimated resources requirements. Additionally, because there can be a significant difference in resource usage between peak-load and off-peak loads, reserved resources may be wasted. As such, current allocation systems may waste cloud resources.

Furthermore, current allocation systems model the resource capacity of the cloud computing cluster as a single monolithic block. Current allocation systems do not enable individual views and controls of each machine. Therefore, when the current allocation systems make scheduling decisions, the current allocation systems are unable to adjust a resource to accommodate simultaneous execution of one or more executable jobs or services.

Moreover, the single monolithic view of the total resource capacity of the cloud cluster ignores the impacts of resource fragmentation.

As such, a real-time, dynamic resource optimization system for cloud containers is desirable. It would be desirable for such a real-time, dynamic resource optimization system for cloud containers to learn and develop temporal resource usage patterns of applications using a deep neural network (“DNN”). It would be further desirable for the real-time, dynamic resource optimization system for cloud containers to schedule executable jobs based on resource usage patterns.

### SUMMARY OF THE DISCLOSURE

A real-time, dynamic resource optimization system for cloud computing containers is provided. The real-time, dynamic resource optimization system for cloud computing containers may include a scheduler that learns and develops various temporal resource usage patterns of applications using a deep neural network (“DNN”). The real-time, dynamic resource optimization system for cloud computing containers may reduce resource competition across executable jobs executing within a server. The real-time, dynamic resource optimization system for cloud computing containers may optimize the cloud cluster for overall cloud cluster utilization.

The real-time, dynamic resource optimization system for cloud computing containers may include a two-layer infrastructure arrangement. A first layer may include a container orchestration engine. The container orchestration engine may include an execution hub. The execution hub may receive the metadata of the jobs which are in an execution queue. The execution hub may convert the metadata into visual data. The visual data may be transmittable through a Zigbee communication engine.

A Zigbee communication engine may be a communication engine that conforms to the Zigbee communication protocols. Zigbee communication protocols are used to create area networks with small, low-power digital radios. Zigbee communication protocols may be used to generate low-power, low-data-rate and close proximity wireless networks.

There may be three classes of devices that operate a Zigbee communication protocol: Zigbee coordinator, Zigbee router and Zigbee end device.

The Zigbee coordinator may originate the network. As such, each Zigbee network may have one Zigbee coordinator. A Zigbee coordinator may be the most capable device within a Zigbee network. The Zigbee coordinator may store information about the network. The Zigbee coordinator may operate as the trust center and repository for security keys. The Zigbee coordinator may form the root node of the network. At times, the Zigbee coordinator may bridge to other networks.

The Zigbee router may execute an application function. The Zigbee router may pass data to other devices. As such, the Zigbee router may operate as an intermediate router. The Zigbee router may be mains-powered –i.e., receive electricity from an electrical system. The Zigbee router may be continuously available on the network. The Zigbee router may be referred to as a Zigbee repeater or a Zigbee range extender. The Zigbee router may be a node or a parent node on the network.

The Zigbee end device may include sufficient functionality to communicate with a parent node, such as, for example, the Zigbee coordinator or Zigbee router. The Zigbee end device may be incapable of relaying data from other devices. The limited capability of the Zigbee end device may allow the Zigbee end device to be inactive for a significant amount of time. Because many Zigbee end devices are battery-powered, the inactive properties of the Zigbee end device may enable the Zigbee end device to maintain a long battery life. It should be noted that the Zigbee end device may utilize less memory than the Zigbee coordinator or the Zigbee router.

A second layer may include server infrastructure. The server infrastructure may receive the emitted information from the cloud container architecture. The server infrastructure may feed the emitted data into a DNN model. The DNN model may generate a job schedule for the jobs in the queue. The DNN model may transmit the job schedule back to the execution hub.

The real-time, dynamic resource optimization system for cloud computing containers may be a self-learning scheduler. The real-time, dynamic resource optimization system for cloud computing containers may assign containerized applications in physical and/or virtual locations to align the resource usages, minimize resource conflicts, maintain quality of service and improve utilization.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows still another illustrative diagram in accordance with principles of the disclosure;

FIG. 4 shows yet another illustrative diagram in accordance with principles of the disclosure;

FIG. 5 shows still another illustrative diagram in accordance with principles of the disclosure; and

FIG. 6 shows yet another illustrative diagram in accordance with principles of the disclosure.

### DETAILED DESCRIPTION OF THE DISCLOSURE

Systems, apparatus and methods for computing resource allocation using a Zigbee-enabled cloud container computing resource system is provided.

Methods may include receiving a plurality of executable jobs at an execution hub. The execution hub may be located within a cloud-based computing container.

Methods may include retrieving metadata for each executable job included in the plurality of executable jobs. The metadata may include executable job details. The executable job details may include a number of central processing unit (“CPU”) processing cycles requisite to complete the executable job. The executable job details may also include a number of bytes of memory requisite to complete the executable job. The executable job details may include a processing timespan requisite to complete the executable job. The executable job details may include an equation that describes a trendline. The trendline may indicate resource consumption levels expected at various durations during the execution of the job.

Methods may include converting, at the execution hub, the metadata for each executable job into a visual data set for each executable job. The converting may be based on, or executed by, a DNN. The DNN may be located within the execution hub.

Methods may include transmitting each visual data set from the execution hub to an initial review engine. The initial review engine may execute a preliminary review of each visual data set.

Methods may include transmitting, from the initial review engine, each visual data set that failed the preliminary review, to the execution hub for insertion into an exception queue. Methods may include transmitting, from the initial review engine, each visual data set that passed the preliminary review, to a processing queue.

Methods may include transmitting, from the processing queue, each visual data set that corresponds to an overridden job and/or a one-time request job, to the execution hub for insertion into the exception queue.

Methods may include transmitting, from the processing queue to a Zigbee communication engine, each visual data set that corresponds to an executable job schedulable by the Zigbee communication engine. The Zigbee communication engine may include a synchronization engine, a broadcasting engine, one or more transmitters and one or more receptors. The Zigbee communication engine may be a Zigbee coordinator.

Methods may include validating, at the Zigbee communication engine, the one or more visual data sets that correspond to an executable job schedulable by the Zigbee communication engine.

Upon validation of the one or more visual data sets at the Zigbee communication engine, methods may include labeling each validated visual data set as a finalized visual data set. Upon validation of the one or more visual data sets at the Zigbee communication engine, methods may also include initiating a Visible Light Communication (“VLC”) engine. Upon validation of the one or more visual data sets at the Zigbee communication engine, methods may also include electronically transmitting each finalized visual data set to a Zigbee communication engine receptor at a target server via the VLC. The Zigbee communication engine receptor may be a Zigbee router and/or a Zigbee end device.

Methods may include extracting the metadata from each finalized visual data set at a deep neural network (“DNN”) at the target server. Methods may include training a model at the target server with the extracted metadata. The training the model may include defining a schedule for the plurality of executable jobs. Methods may include labeling the model as trained. Methods may include transmitting the trained model to the cloud-based computing container.

Methods may include inputting the trained model from the cloud-based computing container to the execution hub. Methods may include triggering execution of the plurality of jobs as defined by the trained model at the execution hub.

Methods may also include executing one or more exception routes upon identification of a default in data processing, Zigbee communication and/or processing queues. Methods may also include, upon failing validation of a visual data set at the Zigbee communication engine, transmitting the failed validation of the visual data set to the initial review engine.

The schedule for the plurality of executable jobs may include one or more resources assigned to each executable job, and a timestamp and/or time duration for each of the one or more resources assigned to each executable job.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

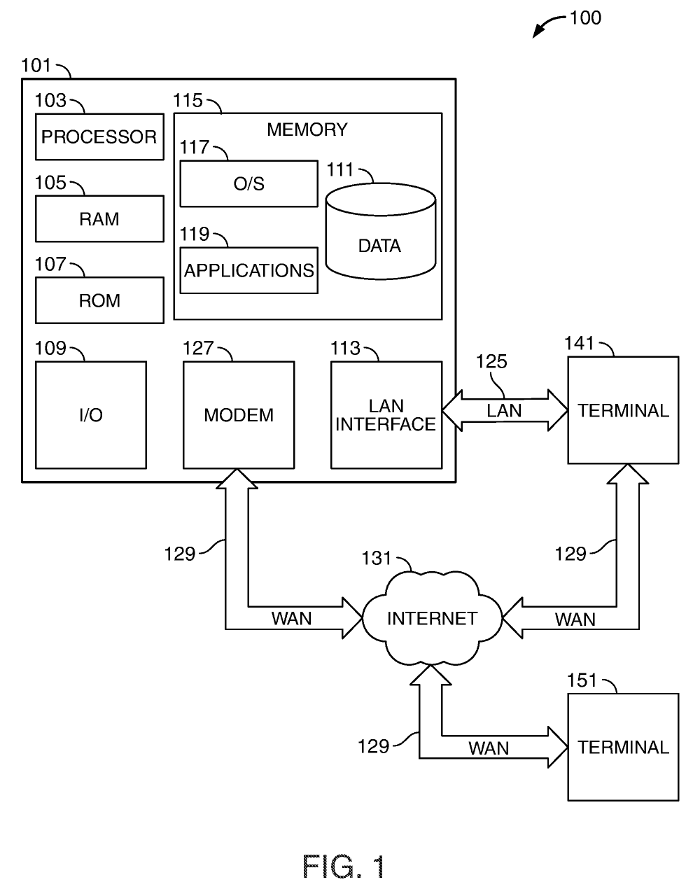

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

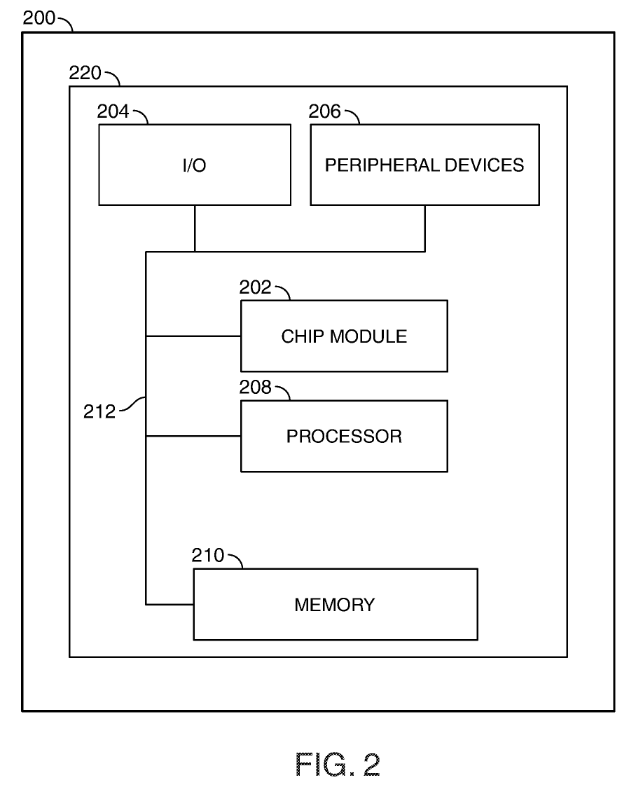

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

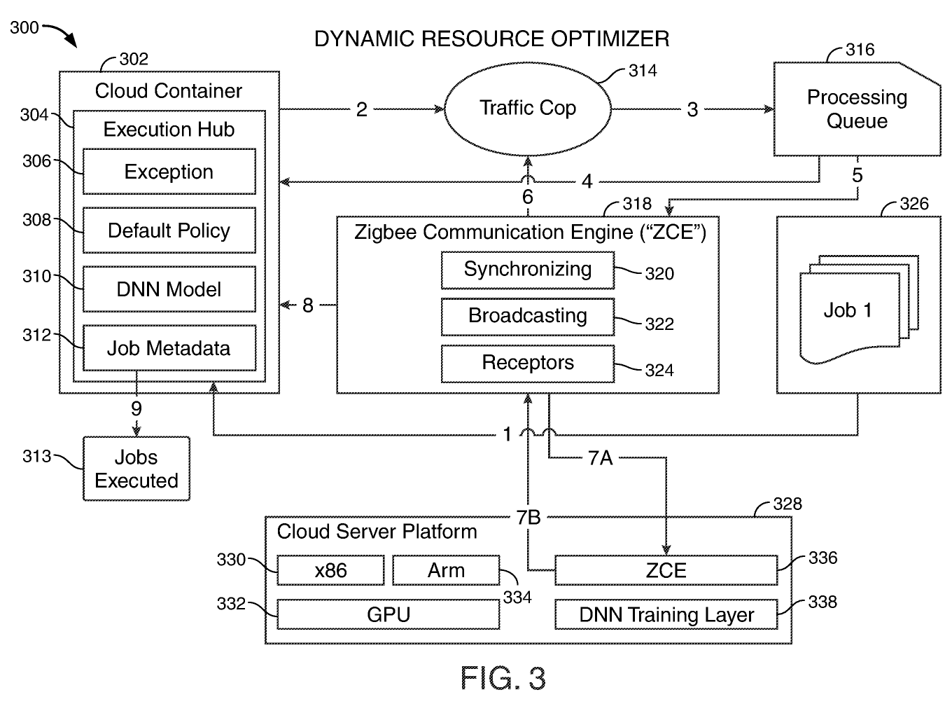

FIG. 3 shows illustrative diagram 300. Step 1 shows a plurality of jobs 326 transmitted to execution hub 304 within cloud container 302. Plurality of jobs 326 may be executed upon being triggered from an execution queue located within execution hub 304.

Execution hub 304 may also include an exception queue 306. Exception queue 306 may include one-time executable jobs –i.e., non-recurring executable jobs– and override executable jobs.

Execution hub 304 may also include a default policy 308. Default policy queue 308 may generate an exception route upon identification of, or receipt of detection of, a default in data handling, Zigbee communication and/or processing queues.

Execution hub 304 may also include a deep neural network (“DNN”) model 310. DNN model 310 may define the schedule of the triggering of the executable jobs.

Execution hub 304 may retrieve metadata 312 relating to executable jobs in the execution queue and convert the retrieved metadata into visual data (also referred to herein as visual cues) based on communications with the DNN.

Step 2 shows the cloud container may transmit the visual data to traffic cop 314. Traffic cop 314 may be an initial review engine. Traffic cop 314 may execute a preliminary review of a consolidated version of the visual data for structural anomalies. When traffic cop 314 detects structural anomalies within the data, traffic cop 314 transmits the visual data back to cloud container 302 for insertion into exception queue 306.

Step 3 shows traffic cop 314 may transmit visual data that passed the preliminary review to processing queue 316.

Step 4 shows a processing queue 316 may transmit any overridden and/or one-time request jobs back to execution hub 304 because the DNN may, at times, be unable to process override jobs and/or one-time request jobs.

Step 5 shows processing queue 316 may transmit a request to Zigbee Communication Engine (“ZCE”) 318. ZCE 318 may include functionalities, such as synchronization 320, broadcasting communicator 322 and receptors 324. Synchronization 320 may enable ZCE 318 to synchronize with other ZCEs. Broadcasting communicator 322 may enable ZCE 318 to broadcast visual data. Receptors 324 may enable ZCE 318 to receive Zigbee communications.

Step 6 shows the ZCE 318 may validate the data before the ZCE 318 initiates a Visible Light Communication (“VLC”). ZCE 318 may transmit anomalous visual data to traffic cop 314.

ZCE 318 may label received visual data that corresponds to non-anomalous data as finalized data. Step 7A shows ZCE 318 may communicate the finalized data through broadcasting communicator 322 to ZCE orchestration 336 at the target server within cloud server platform 328. Cloud server platform 328 may include multiple processors, such as for example x86 330, Arm 334 and GPU 332.

ZCE orchestration 336 may receive the visual data at cloud server platform 328. DNN training layer 338, located within cloud server platform 328, may extract the data received at cloud server platform 328, train a model, and determine a scheduling policy. Determining a scheduling policy may involve assigning jobs to resources, determining a time duration for each job’s execution, determining which jobs are eligible for parallel processing and other processes. The scheduling policy may be based on the job metadata. The metadata may include resource usage, trendlines corresponding to resource usage and other suitable metadata. Resources may include CPU, memory and other suitable resources.

Step 7B shows ZCE orchestration 336 may convert the trained model to visual cues and transmit visual cues corresponding to the trained model and/or the scheduling policy to ZCE 318. At times, the trained model may include the scheduling policy.

Step 8 shows ZCE 318 may transfer the scheduling policy to execution hub 304.

It should be noted that, at times, the trained model and/or scheduling policy may not be converted visual cues prior to transmission to ZCE 318. Also, at times, the trained model and/or scheduling policy may be transmitted directly to execution hub 304.

Step 9 shows the execution hub may use the scheduling policy to schedule the executable jobs and trigger each executable job according to the schedule.

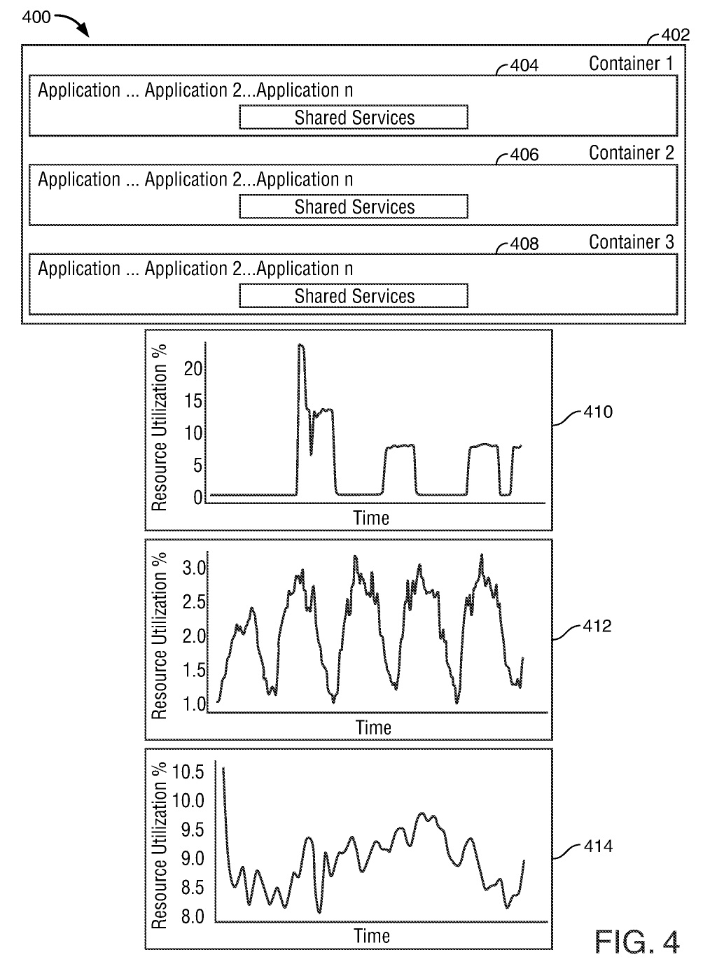

FIG. 4 shows illustrative diagram 400. Illustrative diagram 400 includes container list 402. Container list 402 may include multiple containers, such as container 1 (404), container 2 (406) and container 3 (408). Each of containers 404, 406 and 408 may operate one or more applications.

Resource utilization tables 410, 412 and 414 show the resource utilization of a resources. As shown at resource utilization tables 410, 412 and 414, each of the resources may not maintain static usage. As such, at certain times, the resource may be utilized at a maximum capacity, and at certain times, the resource may be used minimally or not used at all. As such, it is desirable to schedule the resources to be used at, or close to, maximum capacity at all times. As such, certain resources may execute multiple jobs simultaneously to utilize the maximum capacity of the resource.

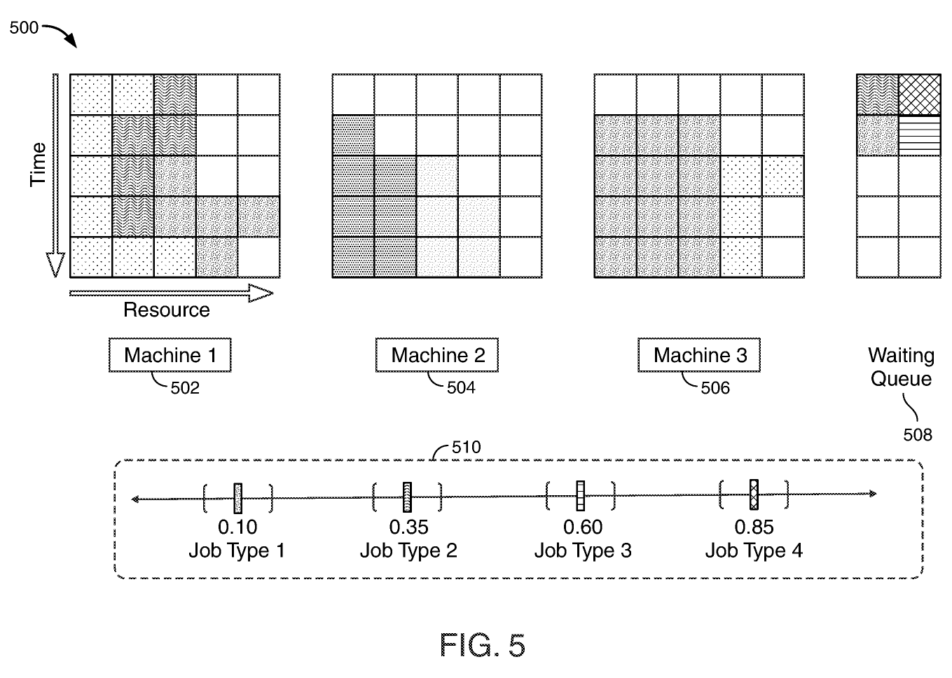

FIG. 5 shows an illustrative diagram 500. Illustrative diagram 500 shows visual diagrams for machine 1, shown at 502, machine 3, shown at 504, and machine 3, shown at 506. There may be multiple jobs waiting in waiting queue 508. Each of the job types may correspond to a different resource required, as indicated within 510. Waiting queue 508 may trigger a job based on a correspondence between the availability of a machine and the resources required by the job. The triggering of the job may be based on a schedule defined by a DNN.

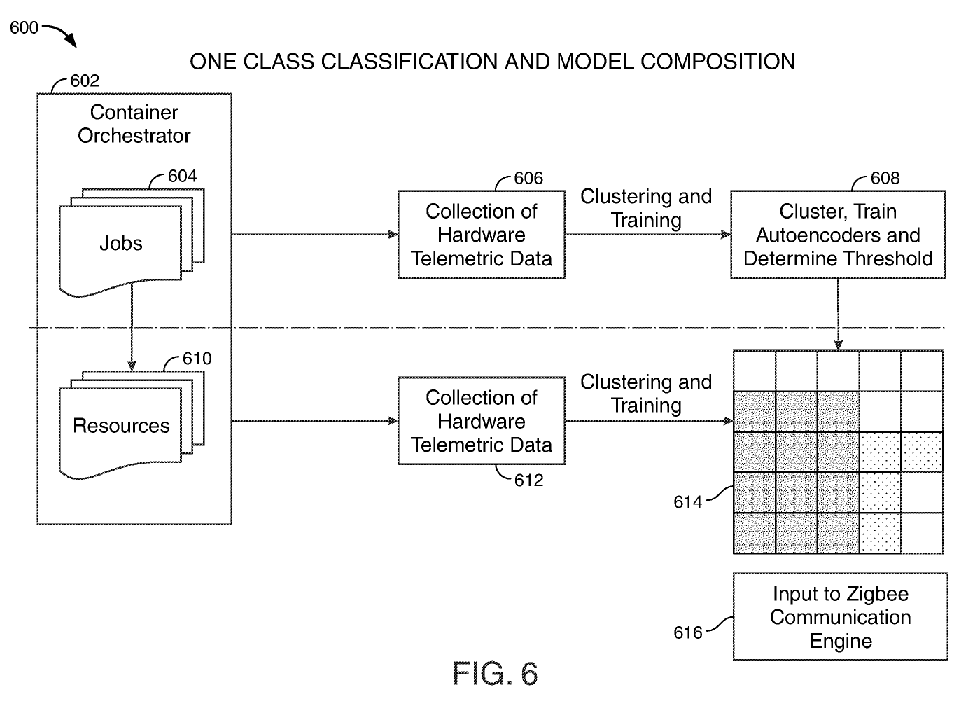

FIG. 6 shows illustrative diagram 600. Illustrative diagram 600 shows one class classification and model composition. Container orchestration 602 may include a plurality of jobs 604 and a plurality of resources 610. A collection of hardware telemetric data 606 may be identified by the plurality of jobs 604. The collection of hardware telemetric data 606 may be clustered and trained. The cluster, trained autoencoders and determined threshold may be input into data structure 614.

A collection of hardware telemetric data 612 may be identified by the plurality of resources 610. The collection of hardware telemetric data 612 may be clustered and trained. The clustered and trained data may be input into data structure 614. Data structure 614 may combine various details relating to jobs 604 and resources 610. Data structure 614 may be input to Zigbee communication engine, as shown at 616.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

Thus, methods and apparatus for a ZIGBEE-enabled cloud container resource optimization system are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for computing resource allocation using a Zigbee-enabled cloud container computing resource system, the method comprising:
receiving, at an execution hub, said execution hub located within a cloud-based computing container, a plurality of executable jobs;
retrieving, at the execution hub, metadata for each executable job included in the plurality of executable jobs, said metadata comprising executable job details, said executable job details comprising:
a number of central processing unit (“CPU”) processing cycles requisite to complete the executable job; and
a number of bytes of memory requisite to complete the executable job;
converting, at the execution hub, the metadata for each executable job into a visual data set, said converting based on a deep neural network (“DNN”), said DNN located within the execution hub;
transmitting each visual data set from the execution hub to an initial review engine, said initial review engine executing a preliminary review of each visual data set;
transmitting, from the initial review engine, each visual data set that failed the preliminary review to the execution hub for insertion into an exception queue;
transmitting, from the initial review engine, each visual data set that passed the preliminary review to a processing queue;
transmitting, from the processing queue, each visual data set that corresponds to an overridden job and/or a one-time request job, to the execution hub for insertion into the exception queue;
transmitting, from the processing queue to a Zigbee communication engine, each visual data set that corresponds to an executable job schedulable by the Zigbee communication engine;
validating, at the Zigbee communication engine, one or more visual data sets, each of the one or more visual data sets corresponds to an executable job schedulable by the Zigbee communication engine;
upon validation of the one or more visual data sets at the Zigbee communication engine:
labeling each validated visual data set as a finalized visual data set; and
initiating a Visible Light Communication (“VLC”) engine;
electronically transmitting each finalized visual data set to a Zigbee communication engine receptor at a target server via the VLC;
extracting the metadata from each finalized visual data set at a deep neural network (“DNN”) at the target server;
training a model at the target server with the extracted metadata, said training the model comprising defining a schedule for the plurality of executable jobs;
labeling the model as trained;
transmitting the trained model to the cloud-based computing container;
inputting the trained model from the cloud-based computing container to the execution hub; and
triggering execution of the plurality of executable jobs as defined by the trained model at the execution hub.

2. The method of claim 1 further comprising executing one or more exception routes upon identification of a default in data processing, Zigbee communication and/or processing queues.

3. The method of claim 1 further comprising upon failing validation of a visual data set at the Zigbee communication engine, transmitting the failed validation of the visual data set to the initial review engine.

4. The method of claim 1 further comprising the executable job details comprising a processing timespan requisite to complete the executable job.

5. The method of claim 1 wherein the Zigbee communication engine comprises a synchronization engine, a broadcasting engine, one or more transmitters and one or more receptors.

6. The method of claim 1 wherein the schedule for the plurality of executable jobs comprises:
one or more resources assigned to each executable job; and
a timestamp and/or time duration for each of the one or more resources assigned to each executable job.

7. A method for computing resource allocation using a Zigbee-enabled cloud container computing resource system, the method comprising:
receiving, at an execution hub, said execution hub located within a cloud-based computing container, a plurality of executable jobs at an execution hub;
retrieving, at the execution hub, metadata for each executable job included in the plurality of executable jobs;
converting, at the execution hub, the metadata for each executable job into a visual data set for each executable job, said converting based on a deep neural network (“DNN”), said DNN located within the execution hub;
transmitting each visual data set from the execution hub to an initial review engine, said initial review engine executing a preliminary review of each visual data set;
transmitting, from the initial review engine, each visual data set that passed the preliminary review, to a processing queue;
transmitting, from the processing queue to a Zigbee communication engine, each visual data set that corresponds to an executable job schedulable by the Zigbee communication engine;
validating, at the Zigbee communication engine, one or more visual data sets, each of the one or more visual data sets corresponds to an executable job schedulable by the Zigbee communication engine;
upon validation of the one or more visual data sets at the Zigbee communication engine:
identifying each validated visual data set as a finalized visual data set; and
initiating a Visible Light Communication (“VLC”) engine;
electronically transmitting each finalized visual data set to a Zigbee communication engine receptor at a target server via the VLC;
extracting the metadata from each finalized visual data set at a DNN at the target server;
training a model at the target server with the extracted metadata, said training the model comprising defining a schedule for the plurality of executable jobs;
transmitting the trained model to the cloud-based computing container;
inputting the trained model from the cloud-based computing container to the execution hub; and
triggering execution of the plurality of jobs as defined by the trained model at the execution hub.

8. The method of claim 7 further comprising executing one or more exception routes upon identification of a default in data processing, Zigbee communication and/or processing queues.

9. The method of claim 7 further comprising upon failing validation of a visual data set at the Zigbee communication engine, transmitting the failed validation of the visual data set to the initial review engine.

10. The method of claim 7 wherein the metadata comprises executable job details comprising a processing timespan requisite to complete the executable job.

11. The method of claim 7 wherein the Zigbee communication engine comprises a synchronization engine, a broadcasting engine, one or more transmitters and one or more receptors.

12. The method of claim 7 wherein the schedule for the plurality of executable jobs comprises:
one or more resources assigned to each executable job; and
a timestamp and/or time duration for each of the one or more resources assigned to each executable job.

13. A Zigbee-enabled cloud container resource system, the system comprising:
a cloud container, said cloud container comprising an execution hub, said execution hub operable to:
receive an executable job for execution; and
electronically convert a metadata set relating to the received executable job into a visual data set;
an initial review engine, said initial review engine operable to:
execute a preliminary review of the visual data set;
determine, based on the preliminary review, that the visual data set passed the preliminary review; and
electronically transmit the visual data set to a processing queue;
the processing queue, said processing queue operable to:
label the visual data set as:
corresponding to an overridden executable job;
corresponding to a one-time request executable job; or
corresponding to an executable job schedulable by a Zigbee communication engine (“ZCE”);
transmit the visual data set that corresponds to the overridden executable job to the execution hub for insertion into an exception queue at the execution hub; and
transmit the visual data set that corresponds to the one-time request job to the execution hub for insertion into an exception queue at the execution hub; and
transmit the visual data set that corresponds to the executable job schedulable by the ZCE to the ZCE;
the Zigbee communication engine (“ZCE”), said ZCE operable to:
validate the visual data set that corresponds to the executable job schedulable by the ZCE;
identify the validated visual data set as a finalized visual data set;
initiate a Visible Light Communication (“VLC”) engine;
electronically transmit the finalized visual data set to a ZCE receptor via the VLC engine, said ZCE receptor located at a cloud server platform;
the cloud server platform, said cloud server platform comprising a deep neural network (“DNN”) and a model, said cloud server platform operable to:
extract, at the DNN, the metadata set from the finalized visual data set;
train the model with the extracted metadata set, said model comprising a schedule of execution of the executable job and one or more other executable jobs;
transmit the schedule of execution of the executable job and one or more other executable jobs to the cloud container;
the cloud container is further operable to:
input the schedule of execution of the executable job and one or more other executable jobs to the execution hub; and
trigger execution of the executable job and the one or more other executable jobs as electronically communicated by the schedule of execution of the executable job and one or more other executable jobs.

14. The Zigbee-enabled cloud container resource system of claim 13 wherein the model comprises the DNN.

15. The Zigbee-enabled cloud container resource system of claim 13 wherein the ZCE comprises a synchronization engine, a broadcasting engine, one or more transmitters and one or more receptors.

16. The Zigbee-enabled cloud container resource system of claim 13 wherein the metadata set comprises executable job details of the executable job.

17. The Zigbee-enabled cloud container resource system of claim 16 wherein the executable job details comprise:
a number of central processing unit (“CPU”) processing cycles requisite to complete the executable job; and
a number of bytes of memory requisite to complete the executable job.

18. The Zigbee-enabled cloud container resource system of claim 17 wherein the executable job details further comprise a processing timespan requisite to complete the executable job.

19. The Zigbee-enabled cloud container resource system of claim 13 wherein the schedule of execution of the executable job and one or more other executable jobs comprises:
one or more resources assigned to the execution of each executable job identified by: the executable job and the one or more other executable jobs; and
a timestamp for executing each executable job identified by: the executable job and the one or more other executable jobs.
